(19) United States
(12) Patent Application Publication
(10) Pub. No.: US 2007/0110057 A1
(43) Pub. Date: May 17, 2007

(54) Method and apparatus for transmitting service guide source in a mobile broadcast system

(76) Inventors: Sung-Oh Hwang, Yongin-si (KR); Kook-Heui Lee, Yongin-si (KR); Byung-Rae Lee, Yongin-si (KR); Jae-Kwon Oh, Seoul (KR); Bo-Sun Jung, Seongnam-si (KR); Jong-Hyo Lee, Pycongtack-si (KR); Jae-Yong Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/593,646

(22) Filed: Nov. 7, 2006

(30) Foreign Application Priority Data
Nov. 7, 2005 (KR) 10-2005-0106214
Mar. 3, 2006 (KR) 10-2006-0020664

(51) Int. Cl. H04L 12/56

(52) U.S. Cl. 370/389; 370/432; 709/227; 709/231

(57) ABSTRACT

A method and apparatus is provided for transmitting information necessary for the generation of a service guide for a mobile broadcast service in a broadcast system supporting the mobile broadcast service. A Content Creation (CC) block transmits a service guide request message including various sources necessary for the generation of a service guide to a Service Guide Application Source (SGAS). The SGAS transmits the service guide request message to a Service Guide Generation (SG-G) unit over a backend interface. The SG-G generates a service guide using various sources included in the service guide request message, and transmits a service guide generation completion message indicating completion of the generation of the service guide to the SGAS.

### CROSS-REFERENCE TO RELATED APPLICATIONS

This application claims the benefit under 35 U.S.C. §119(a) of Korean Patent Application No. 10-2005-0106214, entitled “Method and Apparatus for Transmitting Service Guide Context in a Mobile Broadcast System”, filed Nov. 7, 2005 in the Korean Intellectual Property Office, and Korean Patent Application No. 10-2006-0020664, entitled “Method and Apparatus for Transmitting Service Guide Context in a Mobile Broadcast System”, filed Mar. 3, 2006 in the Korean Intellectual Property Office, the entire disclosures of both of which are hereby incorporated by reference.

### BACKGROUND OF THE INVENTION

1. Field of the Invention

The present invention relates generally to a method and apparatus for transmitting a service guide for broadcast reception in a mobile broadcast system. In particular, the present invention relates to a method and apparatus for transmitting a service guide source for allowing a mobile terminal to easily receive a service guide in a mobile broadcast system.

2. Description of the Related Art

The mobile communication market continuously requires the production of new services through the recombination or integration of new and existing technologies. Today, with the development of communication and broadcast technologies, the conventional broadcast system or mobile communication system has reached the phase of providing broadcast services through portable terminals (or mobile terminals), such as mobile phones, personal digital assistants (PDA), and so forth. Due to the latent and actual market needs and the increasing user demand for multimedia services, the service providers' intended strategies for providing new services such as broadcast service in addition to the existing voice service, and the identified interests of Information Technology (IT) companies which are bolstering their mobile communication businesses to meet the user's demands, convergence of the mobile communication service and the Internet Protocol (IP) has now become the main development of the next generation mobile communication technologies.

Open Mobile Alliance (OMA), a group for studying the standards for interworking between individual mobile solutions, serves to define various application standards for mobile games and Internet services. Of the OMA working groups, Open Mobile Alliance Browser and Content Mobile Broadcast Sub Working Group (OMA BAC BCAST) is now performing research on technology for providing broadcast services using mobile terminals.

In a mobile broadcast system, a mobile terminal desiring to receive a broadcast service should receive so-called service guide information containing description information for the service itself, charging information for the service, and information on a receiving method for the service. The mobile terminal can then receive the corresponding service using the service guide information.

Accordingly, a need exist for an improved system and method for providing the conventional mobile broadcast system with the sources necessary for the generation of a service guide and to then generate the service guide. The mobile broadcast system should provide information on the service, content and schedule. In addition, a need exists for a system and method that is capable of determining whether to execute a provided message, and sending a response indicating whether to execute the corresponding message.

### SUMMARY OF THE INVENTION

It is, therefore, an object of embodiments of the present invention to substantially solve the above and other problems, and provide a service guide source transmission method and apparatus for effectively and efficiently transmitting a service guide to a mobile terminal in a mobile broadcast system.

It is another object of embodiments of the present invention to provide a service guide source transmission method and apparatus for providing service/content information and scheduling information for the generation of a service guide in a mobile broadcast system.

According to one aspect of embodiments of the present invention, a method is provided for transmitting information necessary for the generation of a service guide for a mobile broadcast service in a broadcast system supporting the mobile broadcast service. The method comprises transmitting, by a Content Creation (CC) block for providing a broadcast service, a service guide request message including various sources necessary for the generation of a service guide to a Service Guide Application Source (SGAS), transmitting, by the SGAS, the service guide request message to a Service Guide Generation (SG-G) unit over a backend interface, and generating, by the SG-G, a service guide using various sources included in the service guide request message and transmitting a service guide generation completion message indicating the completion of the generation of the service guide to the SGAS.

According to another aspect of embodiments of the present invention, an apparatus is provided for transmitting information necessary for the generation of a service guide for a mobile broadcast service in a broadcast system supporting the mobile broadcast service. The apparatus comprises a Content Creation (CC) block for transmitting a service guide request message including various sources necessary for the generation of a service guide to a Service Guide Application Source (SGAS), the SGAS for transmitting the service guide request message to a Service Guide Generation (SG-G) unit over a backend interface, and the SG-G for generating a service guide using various sources included in the service guide request message and transmitting a service guide generation completion message indicating the completion of the generation of the service guide to the SGAS.

### BRIEF DESCRIPTION OF THE DRAWINGS

The above and other objects, features and advantages of embodiments of the present invention will become more apparent from the following detailed description when taken in conjunction with the accompanying drawings, in which:

FIG. 1 is a block diagram illustrating an exemplary structure of a service guide used for receiving a broadcast service in a mobile broadcast system to which embodiments of the present invention can be applied;

FIG. 2 is a block diagram illustrating an exemplary process in which a mobile terminal receives individual fragments which are basic units of a service guide in a mobile broadcast system to which embodiments of the present invention can be applied;

FIG. 3 is a block diagram illustrating exemplary architecture of a mobile broadcast system for transmitting a service guide to a mobile terminal according to an exemplary embodiment of the present invention;

FIG. 4 illustrates an exemplary structure of a message schema table that can be applied to embodiments of the present invention;

FIG. 5 is a signaling diagram illustrating an example of message flow between logical entities for generating a service guide in OMA BCAST;

FIG. 6 is a block diagram illustrating an exemplary protocol stack that can be used for transmitting service guide-related information in an SG-2 interface according to an embodiment of the present invention;

FIG. 7 is a signaling diagram illustrating an exemplary operation of transmitting a service guide request message over an SG-2 interface according to an embodiment of the present invention;

FIG. 8 is a block diagram illustrating an exemplary protocol stack that can be used for delivering a request message for service guide source provisioning according to an embodiment of the present invention; and

FIG. 9 is a signaling diagram illustrating an exemplary operation of delivering a request message for service guide source provisioning according to an embodiment of the present invention.

Throughout the drawings, like reference numerals will be understood to refer to like parts, components and structures.

### DETAILED DESCRIPTION OF EXEMPLARY EMBODIMENTS

Exemplary embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness.

A description of the present invention will be made with reference to the OMA BCAST technology which is one of several mobile broadcast technologies, by way of example only. The description does not limit the scope of the present invention to the use of OMA BCAST technology, and embodiments of the present invention can be applied to any system having the same or similar technical background.

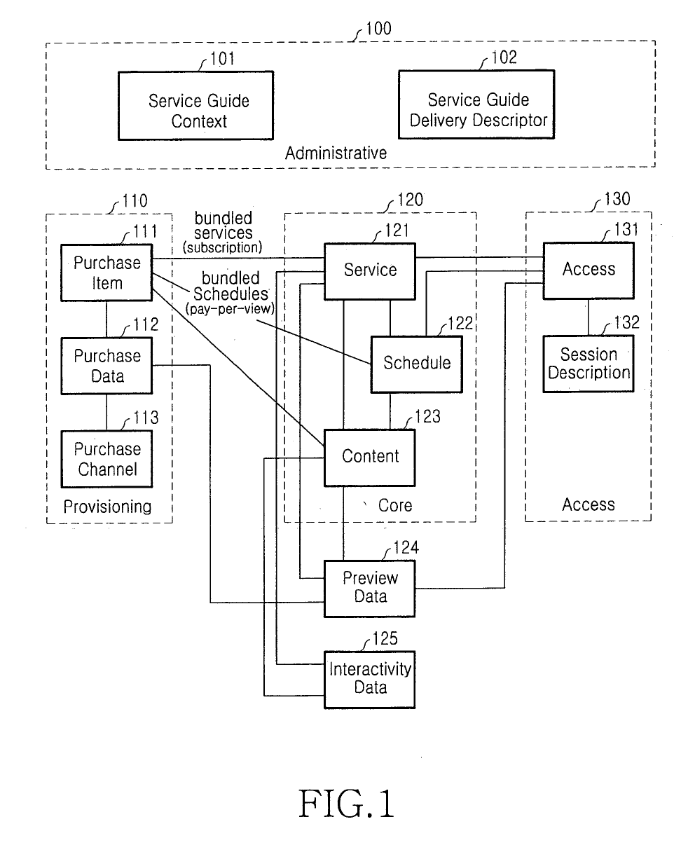

FIG. 1 is a block diagram illustrating an exemplary structure of a service guide used for receiving a broadcast service in a mobile broadcast system to which embodiments of the present invention can be applied. The structure of FIG. 1 has been proposed by the OMA BAC BCAST to provide a broadcast service to a mobile terminal. One service guide is comprised of fragments having their own specific purposes, and the fragments are divided into four groups according to their usage, as shown in FIG. 1.

The exemplary service guide shown in FIG. 1 is comprised of an Administrative group 100, a Provisioning Group 110, a Core Group 120, which is a core part of the service guide such as service, content and schedule, and an Access Group 130. In FIG. 1, a solid line connecting the fragments denotes a cross-reference between the fragments.

The Administrative group 100 is a group for providing basic information needed by a mobile terminal to receive a service guide. The Administrative group 100 comprises a Service Guide Context fragment 101 and a Service Guide Delivery Descriptor (SGDD) fragment 102.

The Service Guide Context fragment 101 provides a service guide identifier (ID), identification information of the service provider that generated and transmitted the service guide, information on an operator that distributes a service guide or its location information, and information on the connection with the Service Guide Delivery Descriptor (SGDD) fragment 102. The SGDD 102 provides information on a delivery session where a Service Guide Delivery Unit (SGDU) containing a fragment which is the minimum unit constituting the service guide is located, and also provides grouping information for the SGDU and information on an entry point for receiving a notification message.

The Provisioning group 110 is a group for providing charging information for service reception. The Provisioning group 110 comprises a Purchase Item fragment 111, a Purchase Data fragment 112, and a Purchase Channel fragment 113. The Purchase Item fragment 111 provides charging information for a service or a service bundle, the Purchase Data fragment 112 indicates actual price information for a purchase item, and the Purchase Channel fragment 113 provides access information so that the service user may actually purchase the service.

The Core group 120 is a group for providing information on the service itself The Core group 120 comprises a Service fragment 121, a Schedule fragment 122, and a Content fragment 123.

The Service fragment 121 provides a description of the service itself that the user will receive, and also provides the genre and service area information and the information indicating with which content the service can be configured.

The Schedule fragment 122 provides information on the time at which the service can be provided and used. The Content fragment 123 provides information on a plurality of contents constituting the service, i.e. information on description of contents, target user group, service area, genre, and so forth.

The Access group 130 comprises an Access fragment 131 and a Session Description fragment 132. The Access group 130 provides service access information indicating how to receive the services provided through the Core group 120, and detailed information on the session in which the contents constituting the corresponding service are transmitted, so as to allow the mobile terminal to access the corresponding service.

The Access fragment 131 provides a plurality of access methods for one service to the mobile terminal, thereby providing a method capable of accessing various additional services based on one service. The Access fragment 131 also provides session information.

The Session Description fragment 132 can also be included in the Access fragment 131, and provides location information in URI form so that the terminal can detect corresponding session description information. The Session Description fragment 132 provides address information and codec information for the multimedia contents existing in the corresponding session.

In addition, the service guide information, as shown in FIG. 1, can further comprise a Preview Data fragment 124 that provides a preview and icon for the service and content, in addition to the four fragments described above. An Interactivity Data fragment 125 can also be provided for supporting an interactive service possibly existing in a particular schedule during the broadcast service. The Interactivity Data fragment 125, through which an interactive service such as music purchases and voting services are supported during the broadcast service, also provides the information on the document used for the corresponding interactive service.

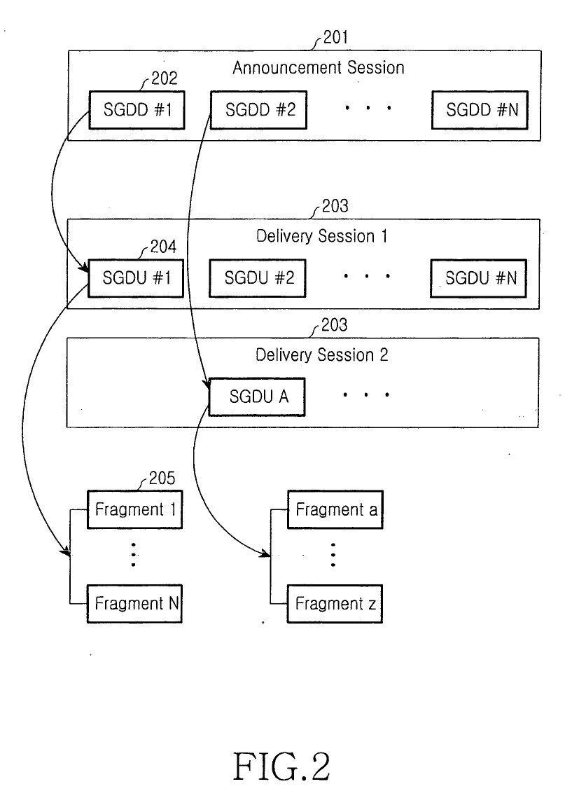

FIG. 2 is a block diagram illustrating an exemplary process in which a mobile terminal receives individual fragments which are basic units of a service guide in a mobile broadcast system to which embodiments of the present invention can be applied.

In the mobile broadcast system, a service guide, which is an aggregate of binary Objects, is delivered to a mobile terminal, and Service Guide Delivery Units (SGDUs) SGDU #1 to SGDU #N of FIG. 2 show such Objects. As shown in FIG. 2, a first SGDU 204 includes one or more fragments 205 of Fragment #1 to Fragment #N for the service guide. The fragments 205 can comprise the Service fragment 121, the Schedule fragment 122, the Content fragment 123, the Preview Data fragment 124, the Access fragment 131, the Session Description fragment 132, the Purchase Item fragment 111, the Purchase Data fragment 112, and the Purchase Channel fragment 113, as described in FIG. 1.

An Object of the SGDU 204 is delivered to a mobile terminal over a broadcast or interaction channel, and Service Guide Delivery Descriptors (SGDDs) 202 of SGDD #1 to SGDD #N shown in FIG. 2 include information used for receiving such Objects. Therefore, the individual fragments constituting the service guide are delivered to the mobile terminal along with the SGDU 204 indicated by the SGDD 202.

The session over which the service guide is delivered is classified into two types, including an Announcement Session 201 and a Delivery Session 203. The mobile terminal receives the SGDD 202 from the system over the Announcement Session 201, detects the Delivery Session 203 through the received SGDD 202 to receive the SGDU 204 existing in the corresponding session, and receives the corresponding fragment constituting the service guide.

The Delivery Session 203 can comprise a plurality of Delivery Sessions corresponding to Announcement Sessions, wherein for example, a Delivery Session 2 can comprise Service Guide Delivery Units (SGDUs) SGDU A and so forth, such that the individual Fragments a to Fragment z are delivered to the mobile terminal along with the SGDU A indicated by the SGDD #2.

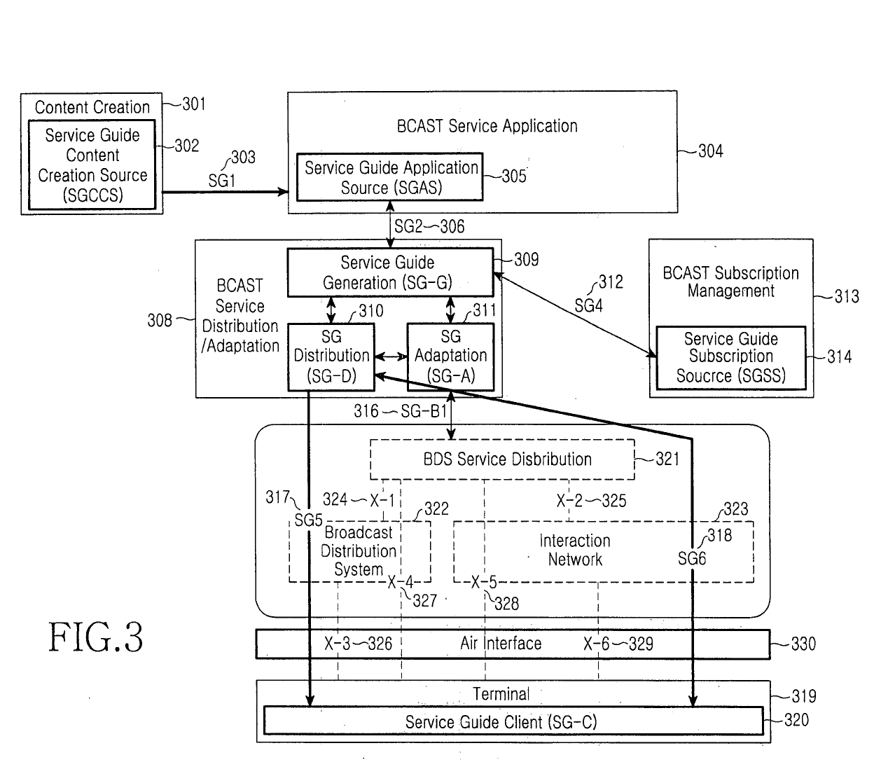

FIG. 3 is a block diagram illustrating exemplary architecture of a mobile broadcast system for transmitting a service guide to a mobile terminal according to an exemplary embodiment of the present invention.

Table 1 and Table 2 below show by way of example, the interfaces used between the constituent elements (or logical entities) of FIG. 3.

TABLE 1

| Interface | Description |
|---|---|
| SG-1 | Server-to-server communications for delivering content attributes such as description |
| | information, location information, target terminal capabilities, target user profile, and so |
| | forth, either in the form of BCAST service guide fragments or in a proprietary format. |
| SG-2 | Server-to-server communications for delivering BCAST service attributes such as |
| | service/content description information, scheduling information, location information, |
| | target terminal capabilities, target user profile, and so forth, in the form of BCAST service |
| | guide fragments. |
| SG-B1 | Server-to-server communications for either delivering BDS specific attributes from BDS to |
| | BCAST Service Guide Adaptation function, to assist Service Guide adaptation to specific |
| | BDS, or to deliver BCAST Service Guide attributes to BDS for BDS specific adaptation |
| | and distribution. |
| SG-4 | Server-to-server communications for delivering provisioning information, purchase |
| | information, subscription information, promotional information, and so forth, in the form of |
| | BCAST service guide fragments. |
| SG-5 | Delivery of BCAST Service Guide through Broadcast Channel, over IP. |
| SG-6 | Delivery of BCAST Service Guide through Interaction Channel. Interactive access to |
| | retrieve Service Guide or additional information related to Service Guide, for example, by |
| | HTTP, SMS, or MMS. |

TABLE 2

| Interface | Description |
|---|---|
| X-1 | Reference Point between BDS Service Distribution and BDS. |
| X-2 | Reference Point between BDS Service Distribution |
| | and Interaction Network. |
| X-3 | Reference Point between BDS and Terminal. |
| X-4 | Reference Point between BDS Service Distribution and |
| | Terminal over Broadcast Channel. |
| X-5 | Reference Point between BDS Service Distribution and |
| | Terminal over Interaction Channel. |
| X-6 | Reference Point between Interaction Network and Terminal. |

Referring to FIG. 3, a Content Creation (CC) block 301 is a provider of Broadcast Service (hereinafter referred to as “BCAST service”), and the BCAST service can include conventional audio/video broadcast service, music/data file download service, and so forth. The Content Creation block 301, using a Service Guide Content Creation Source (SGCCS) 302, delivers content information necessary for the creation of a service guide for the BCAST service, capability information of mobile terminals, user profile, and content time information to a Service Guide Application Source (SGAS) 305 in a BCAST Service Application block 304 through an SG-1 interface 303 of Table 1.

The BCAST Service Application block 304 processes data of the BCAST service provided from the Content Creation block 301 in the form appropriate for a BCAST network, thereby making BCAST service data. In addition, the BCAST Service Application block 304 generates standardized metadata necessary for mobile broadcast guide.

The SGAS 305 delivers various sources necessary for the generation of a service guide, such as detailed service/content information, scheduling information, and location information, including the information provided from the SGCCS 302, to a Service Guide Generation (SG-G) block 309 in a BCAST Service Distribution/Adaptation (BSD/A) block 308 via an SG-2 interface 306.

The BCAST Service Distribution/Adaptation block 308 has a function of setting up a bearer over which it will transmit the BCAST service data provided from the BCAST Service Application block 304, a function of determining transmission scheduling of the BCAST service, and a function of creating mobile broadcast guide information. The BCAST Service Distribution/Adaptation block 308 is connected to a Broadcast Distribution System (BDS) 322, which is a network for transmitting BCAST service data, and an Interaction Network 323 supporting interactive communication.

The service guide generated by the SG-G 309 is delivered to a Terminal 319 via an SG Distribution (SG-D) 310 and an SG-5 interface 317. If the service guide is delivered via the BDS 322 or the Interaction Network 323 supporting interactive communication, or if there is a need for matching with the corresponding system or network, the service guide generated by the SG-G 309 is matched in an SG Adaptation (SG-A) block 311 and then delivered to the SG-D 310, or is delivered to a BDS Service Distribution block 321 via an SG-B1 interface 316.

A BCAST Subscription Management block 313 manages subscription information and service provisioning information for receipt of BCAST service, and device information for a mobile terminal receiving BCAST service. A Service Guide Subscription Source (SGSS) 314 is provided in the BCAST Subscription Management block 313 for delivering sources related to service guide generation, subscription and provisioning, and such sources as purchase information and promotional information, to the SG-G 309 that generates the service guide, via an SG-4 interface 312.

The BDS Service Distribution block 321 serves to distribute all received BCAST services through a broadcast channel or an interaction channel, and is an entity that can exist or not according to the type of the BDS 322. The BDS 322 is a network that transmits BCAST service, and can be a broadcast network such as Digital Video Broadcasting-Handheld (DVB-H), 3GPP-based Multimedia Broadcast and Multicast Services (MBMS), and 3GPP2-based Broadcast and Multicast Services (BCMCS). The Interaction Network 323 transmits BCAST service on a point-to-point basis, or interactively exchanges control information and additional information related to reception of the BCAST service, and can be, for example, the existing cellular network. The BDS 322 is linked to the BDS Service Distribution block 321 via 324, and the Interaction Network 323 is linked to the BDS Service Distribution block 321 via 325. The BDS Service Distribution block 321 is also linked to the Terminal 319 via 327 and 328. Further, the BDS 322 is linked to the Terminal 319 via 326, and the Interaction Network 323 is linked to the Terminal 319 via 329, such as through an air interface 330.

The Terminal 319 is an apparatus that is capable of receiving the BCAST service, and can be connected to the cellular network according to terminal capability. The Terminal 319, including a Service Guide Client (SG-C) 320, receives the service guide delivered via the SG-5 interface 317 or receives the notification message delivered via an SG-6 interface 318, thereby performing an appropriate operation for receipt of the BCAST service.

Table 3 to Table 5 below give a brief description of key elements (logical entities) of FIG. 3 defined in the OMA BCAST service standard.

TABLE 3

| Logical Entity | Description |
|---|---|
| Content Creation | In Content Creation, Service Guide Content Creation Source (SGCCS) may |
| (301) | provide contents and attributes such as content description information, target |
| | terminal capabilities, target user profile, content timing information, and so forth, |
| | and sends them over SG-1 in the form of standardized BCAST Service Guide |
| | fragments, or in a proprietary format. |
| BCAST Service | In BCAST Service Application, Service Guide Application Source (SGAS) |
| Application (304) | provides service/content description information, scheduling information, location |
| | information, target terminal capabilities, target user profile, and so forth, and sends |
| | them over SG-2 in the form of standardized BCAST Service Guide fragments. |
| BCAST | In BCAST Subscription Management, Service Guide Subscription Source (SGSS) |
| Subscription | provides provisioning information, purchase information, subscription information, |
| Management (313) | promotional information, and so forth, and sends them over SG-4 in the form of |
| | Service Guide fragments. |

TABLE 4

| Logical Entity | Description |
|---|---|
| Service Guide | The Service Guide Generation (SG-G) in the network is responsible for receiving |
| Generation (SG-G) | Service Guide fragments from various sources such as SGCCS, SGAS, SGSS over |
| (309) | SG-2 and SG-4 interfaces. SG-G assembles the fragments, such as services and |
| | content access information, according to a standardized schema, and generates |
| | Service Guide which is sent to Service Guide Distribution (SG-D) for transmission. |
| | Before transmission, it is optionally adapted in the Service Guide Adaptation |
| | Function (SG-A) 111 to suit a specific BDS. |
| Service Guide | The Service Guide Client Function (SG-C) in the terminal is responsible for |
| Client Function | receiving the Service Guide information from the underlying BDS, and making the |
| (SG-C) (320) | Service Guide available to the mobile terminal. The SG-C obtains specific Service |
| | Guide information. It may filter it to match the terminal specified criteria (for |
| | example, location, user profile, terminal capabilities and so forth), or it simply |
| | obtains all available Service Guide information. Commonly, the user may view the |
| | Service Guide information in a menu, list or tabular format. SG-C may send a |
| | request to the network through SG-6 to obtain specific Service Guide information, |
| | or the whole Service Guide. |

TABLE 5

| Logical Entity | Description |
|---|---|
| Service Guide | SG-D generates an IP flow to transmit Service Guide over the SG-5 interface and |
| Distribution | the broadcast channel to the SG-C. Before transmission, the SG-G may send |
| (SG-D) (310) | Service Guide to Service Guide Adaptation (SG-A) to adapt the Service Guide to |
| | suit specific BDS, according to the BDS attributes sent by BDS Service |
| | Distribution over SG-B1. The adaptation might result in modification of Service |
| | Guide. Note that, for adaptation purposes, the SG-A may also send the BCAST |
| | Service Guide attributes or BCAST Service Guide fragments over SG-B1 to BDS |
| | Service Distribution for adaptation, wherein this adaptation within BDS Service |
| | Distribution is beyond the scope of BCAST. SG-D may also receive a request for |
| | Service Guide information, and send the requested Service Guide information to |
| | the terminal directly through the interaction channel. SG-D also may filter Service |
| | Guide information from SG-G based on an End User's pre-specified profile. SG-D |
| | may also send the Service Guide to the BDS, which modifies the Service Guide |
| | (e.g., by adding BDS specific information), and further distributes the Service |
| | Guide to the SG-C in a BDS specific manner. |

Before a detailed description of embodiments of the present invention is given, columns of a message schema table used for a better understanding of embodiments of the present invention will be described.

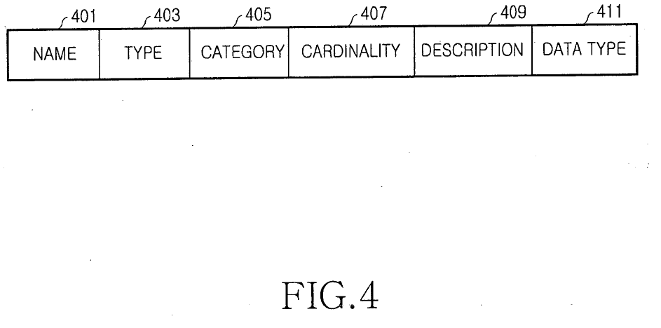

FIG. 4 illustrates an exemplary structure of a message schema table that can be applied to embodiments of the present invention.

Referring to FIG. 4, ‘Name’ 401 indicates names of elements and attributes constituting the corresponding message. ‘Type’ 403 indicates whether the corresponding name 401 has a type of element or attribute. Each element has values of E1, E2, E3 and E4. Here, E1 indicates an upper element for the whole message, E2 indicates sub-element of E1, E3 indicates a sub-element of E2, and E4 indicates a sub-element of E3. The attribute is indicated by A, and A indicates an attribute of the corresponding element. For example, A under E1 indicates an attribute of E1.

‘Category’ 405 is used for indicating whether a corresponding element or attribute is mandatory or optional, and has a value M if the value is mandatory, and a value O if the value is optional. ‘Cardinality’ 407 indicates relations between the elements, and has values of ‘0’, ‘0 . . . 1’, ‘1’, ‘0 . . . n’, and ‘1 . . . n’, where “0” denotes an optional relation, “1” denotes a mandatory relation, and ‘n’ denotes the possibility of having a plurality of values. For example, ‘0 . . . n’ denotes the possibility that there is no corresponding element or that there are n corresponding elements. ‘Description’ 409 defines the meaning of the corresponding element or attribute. ‘Data Type’ 411 indicates a type of program language used for generating the corresponding data. For example, Extensible Markup Language (XML) can be used.

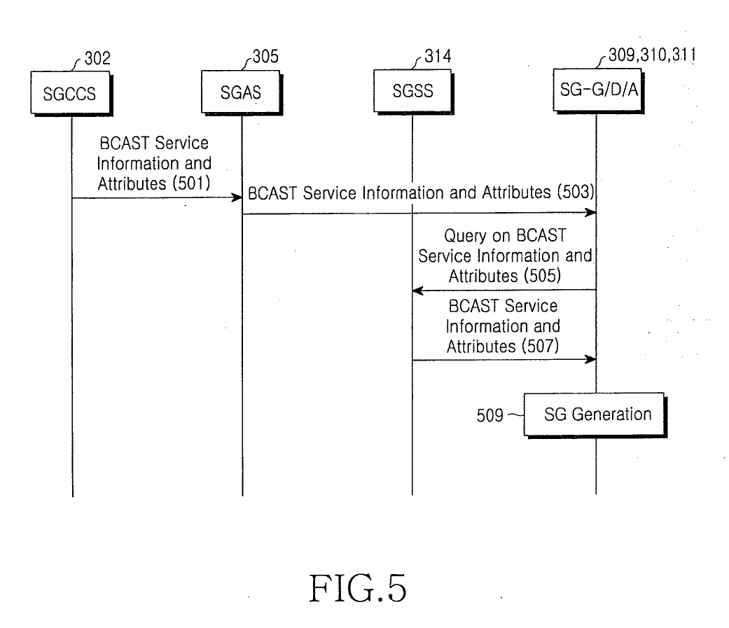

FIG. 5 is a signaling diagram illustrating an exemplary message flow between logical entities for generating a service guide in OMA BCAST.

Referring to FIG. 5, in step 501, an SGCCS 302 delivers BCAST service-related content information and attributes to an SGAS 305. In step 503, the SGAS 305 delivers the content/service information and attributes provided from the SGCCS 302 to SG-G/D/A 309, 310 and 311 according to the BCAST format. In step 505, the SG-G/D/A 309, 310 and 311 send a request for Provisioning-related information to an SGSS 314. In step 507, the SGSS 314 provides the Provisioning-related information to the SG-G/D/A 309, 310 and 311. In step 509, the SG-G/D/A 309, 310 and 311 generate a service guide.

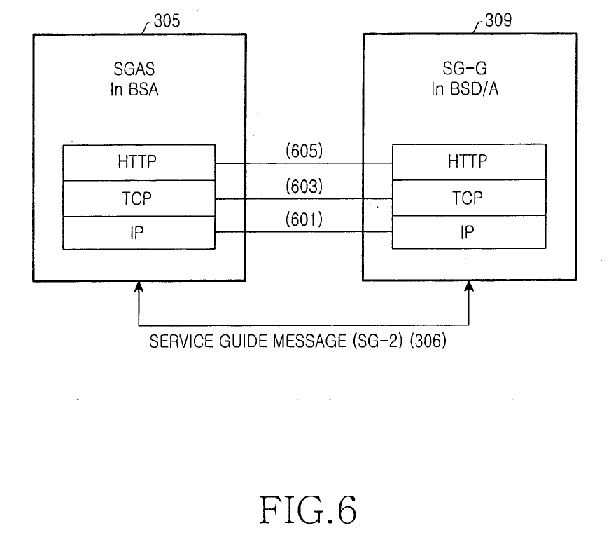

FIG. 6 is a block diagram illustrating an exemplary protocol stack used for transmitting service guide-related information in an SG-2 interface according to an embodiment of the present invention.

Referring to FIGS. 3 and 6, a service guide message delivered over an SG-2 interface 306 can have a Text or XML form. The corresponding service guide message will now be described in greater detail with reference to FIG. 6.

The service guide message delivered over the SG-2 interface 306 is transmitted using Internet Protocol (IP) 601, Transfer Control Protocol (TCP) 603 and Hyper Text Transfer Protocol (HTTP) 605. The SGAS 305 in BSA 304 sends the service guide message to the SG-G 309 in a BSD/A 308 using an HTTP POST scheme. Here, the HTTP POST scheme, unlike the HTTP GET scheme using Universal Resource Locator (URL), denotes a scheme of delivering data using a file without length limitation. After receiving the message from the SGAS 305, the SG-G 309 transmits the results on the service guide generation along with an HTTP RESPONSE message, or by using HTTP POST.

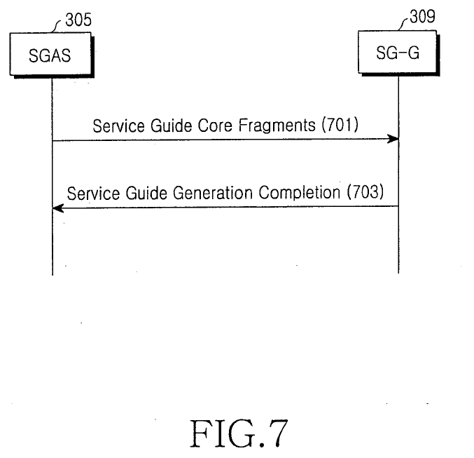

FIG. 7 is a signaling diagram illustrating an exemplary operation of transmitting a service guide request message over an SG-2 interface according to an embodiment of the present invention.

Referring to FIGS. 3 and 7, in step 701, the SGAS 305 provides an SG-G 309 with service/content information and scheduling information for the generation of a core section in the structure of the service guide for receiving the broadcast service in the mobile broadcast system described in FIG. 1, in the form of Service Guide Core Fragments. It will be construed that the Service Guide Core Fragment has the same meaning as the service guide request message. Scheduling information in the delivered information may not be provided. In this case, it can be generated in the BSD/A 308 while the service guide is generated in the SG-G 309.

Examples of the service guide request message provided in step 701 are shown in Tables 6A to 6Y. Service in Table 6A follows ServiceInfo of Table 6C, Content of Table 6B follows ContentInfo of Table 6H, Schedule of Table 6B follows ScheduleInfo of Table 6N, and InteractivityData of Table 6B follows InteractivityDatalnfo of Table 6W. In step 703, the SG-G 309 generates a service guide with the information received from the SGAS 305, and then sends a Service Guide Generation Completion message indicating the completion of the generation to the SGAS 309.

If the service guide is immediately generated and sent, the SG-G 309 can send a result message along with an HTTP Response message in response to the request message provided in step 701. Otherwise, if time is required for the generation of the service guide, the SG-G 309 can close the session to the SGAS 305, and then notify the result message to the SGAS 305 through a HTTP POST using ID and BSAAddress of the SAGSReq message at the generation completion time. Details of the result message are shown in Table 7 below by way of example. Regarding the response to the service guide request of the SGAS 305 in step 703, responses to several requests of the SGAS 305 can be sent from the SG-G 309 to the SGAS 305 using one message.

Table 6A to Table 6Y below provide a detailed description of exemplary elements and attributes constituting the service guide request message. In Table 6A to Table 6Y, XML is used as the data type by way of example only, however, any number of other program languages can be used.

TABLE 6A

| Name | Type | Category | Cardinality | Description | Data Type |
|---|---|---|---|---|---|
| SGASReq | | | | Specifies Service Guide Application | |
| | | | | Sources to generate Service Guide. | |
| | | | | Service, Schedule, and Content | |
| | | | | information are possible values. | |
| | | | | Contains the Following attributes: | |
| | | | | SGASId | |
| | | | | Contains the following elements: | |
| | | | | Service | |
| | | | | Content | |
| | | | | Schedule | |
| | | | | InteractivityData | |
| SGASId | A | M | 1 | Identifier of SGASReq which is the | unsignedInt |
| | | | | message for SGAS to transfer Service | (32bits) |
| | | | | Guide Application Source to SG-G | |
| BSAAddress | A | M | 1 | BSA Address to receive the response of | AnyURI |
| | | | | this request. | |
| Service | E1 | O | 0 . . . N | Specifies the Service Information | ServiceInfo |

TABLE 6B

| Name | Type | Category | Cardinality | Description | Data Type |
|---|---|---|---|---|---|
| Content | E1 | O | 0 . . . N | Specifies Content Information | ContentInfo |
| | | | | FileDescription | |
| Schedule | E | O | 0 . . . N | Specifies Schedule Information | ScheduleInfo |
| | | | | related with Services and Contents | |
| Interactivity | E1 | O | 0 . . . N | InteractivityData fragment. | Interactivity |
| Data | | | | | DataInfo |

TABLE 6C

| Name | Type | Category | Cardinality | Description | Data Type |
|---|---|---|---|---|---|
| ServiceInfo | | | | Specifies the Service Information | |
| | | | | Contains the following attributes: | |
| | | | | id | |
| | | | | version | |
| | | | | type | |
| | | | | ServiceProtection | |
| | | | | Contains the following elements: | |
| | | | | ExtensionURL | |
| | | | | GlobalServiceID | |
| | | | | Name | |
| | | | | Description | |
| | | | | ParentalRating | |
| | | | | TargetUserProfile | |
| | | | | Genre | |
| | | | | UserRating | |
| | | | | Broadcast_area | |
| id | A | M | 1 | ID of the service fragment, globally | AnyURI |
| | | | | unique. | |

TABLE 6D

| Name | Type | Category | Cardinality | Description | Data Type |
|---|---|---|---|---|---|
| Version | A | M | 1 | Version of this fragment. The newer | unsignedInt |
| | | | | version overrides the older one as soon | (32 bits) |
| | | | | as it has been received. | |
| type | A | M | 1 | Type of the service. Allowed values | Integer |
| | | | | are: | (8 bits) |
| | | | | 0 - unspecified | |
| | | | | 1 - Basic TV, non-interactive | |
| | | | | 2 - Basic TV, interactive | |
| | | | | 3 - Clipcast | |
| | | | | 4 - Mixed Basic TV and Clipcast non- | |
| | | | | interactive | |
| | | | | 5 - Mixed Basic TV and Clipcast, with | |
| | | | | interaction | |
| | | | | 6 - Basic Radio, non-interactive | |
| | | | | 7 - Basic Radio, interactive | |
| | | | | 8 - File download services | |
| | | | | 9 - Software management services | |
| | | | | 10 - Notification services | |
| | | | | 11-200 reserved for future use | |
| | | | | 201-255 reserved for proprietary use | |

TABLE 6E

| Name | Type | Category | Cardinality | Description | Data Type |
|---|---|---|---|---|---|
| ServiceProtection | A | O | 0 . . . 1 | Specifies if the service is encrypted | Boolean |
| | | | | (false) or not (true). This is | |
| | | | | recommendation value by SGAS. | |
| ExtensionURL | E1 | O | 0 . . . N | URL containing additional information | AnyURI |
| | | | | related to this fragment in a web page. | |
| | | | | The terminal can fetch further | |
| | | | | information by accessing this URL. | |
| GlobalServiceID | E1 | O | 0 . . . 1 | The globally unique identifier | AnyURI |
| | | | | identifying the service this Service | |
| | | | | fragment describes. | |
| Name | E1 | M | 1 . . . N | Name of the Service, possibly in | String |
| | | | | multiple languages. The language is | |
| | | | | expressed using built-in XML attribute | |
| | | | | xml:lang with this element. | |
| Description | E1 | O | 0 . . . N | Description, possibly in multiple | String |
| | | | | languages. The language is expressed | |
| | | | | using built-in XML attribute xml:lang | |
| | | | | with this element. | |

TABLE 6F

| Name | Type | Category | Cardinality | Description | Data Type |
|---|---|---|---|---|---|
| ParentalRating | E1 | O | 0 . . . 1 | The rating level defining criteria | String |
| | | | | parents may use to determine whether | |
| | | | | the associated item is suitable for | |
| | | | | access by children, defined according | |
| | | | | to the regulatory requirements of the | |
| | | | | service area. | |
| TargetUserProfile | E1 | O | 0 . . . 1 | Profile of the users who the service or | |
| | | | | content is targeting. For example, age, | |
| | | | | gender, occupation, and so forth. | |
| | | | | Details of the sub-elements TBD. | |
| Genre | E1 | O | 0 . . . N | Classification of service associated | String |
| | | | | with characteristic form (e.g. comedy, | |
| | | | | drama). | |
| UserRating | E1 | O | 0 . . . N | Rating information collected from users | Integer |
| | | | | (e.g. favoritism, or recommended age | |
| | | | | limit). | |
| broadcast_area | E1 | O | 0 . . . 1 | Broadcast area to include location | |
| | | | | information for BCAST contents | |
| | | | | Sub-elements: | |
| | | | | target_area | |

TABLE 6G

| Name | Type | Category | Cardinality | Description | Data Type |
|---|---|---|---|---|---|
| target_area | E2 | O | 0 . . . N | The target area to distribute contents | |
| | | | | (as specified in the [OMA MLP] with | |
| | | | | modifications) | |
| | | | | Sub-elements: | |
| | | | | Shape | |
| | | | | cc | |
| | | | | name_area | |
| | | | | zip_code | |
| shape | E3 | O | 0 . . . 1 | Shapes used to represent a geographic | See |
| | | | | area that describes (as specified in the | [OMA |
| | | | | [OMA MLP]). | MLP] |
| cc | E3 | O | 0 . . . 1 | Country code, 1-3 digits e.g. 355 for | See |
| | | | | Albania (as specified in the [OMA | [OMA |
| | | | | MLP]). | MLP] |
| name_area | E3 | O | 0 . . . 1 | Geopolitical name of area such as | See |
| | | | | ‘Seoul’ (as specified in the [OMA | [OMA |
| | | | | MLP]). | MLP] |
| zip_code | E3 | O | 0 . . . 1 | Zip code | Integer |

TABLE 6H

| Name | Type | Category | Cardinality | Description | Data Type |
|---|---|---|---|---|---|
| ContentInfo | | | | Specifies Content Information | |
| | | | | Contains the following attributes: | |
| | | | | id | |
| | | | | version | |
| | | | | ServiceIDRef | |
| | | | | ContentType | |
| | | | | Contains the following sub-elements: | |
| | | | | ExtensionURL | |
| | | | | Name | |
| | | | | Description | |
| | | | | ParentalRating | |
| | | | | TargetUserProfile | |
| | | | | Genre | |
| | | | | UserRating | |
| | | | | broadcast_area | |
| | | | | FileDescription | |
| id | A | M | 1 | ID of the content fragment, globally | AnyURI |
| | | | | unique | |

TABLE 6I

| Name | Type | Category | Cardinality | Description | Data Type |
|---|---|---|---|---|---|
| Version | A | M | 1 | Version of this fragment. The newer | unsignedInt |
| | | | | version overrides the older one as soon | (32 bits) |
| | | | | as it has been received. | |
| ServiceIDRef | A | M | 1 | Reference to the service fragment to | AnyURI |
| | | | | which the Content fragment belongs. | |
| ContentType | A | M | 1 | Type of the media content, defined by | String |
| | | | | MIME media types [RFC2046]. | |
| ExtensionURL | E1 | O | 0 . . . N | URL containing additional information | AnyURI |
| | | | | related to this fragment in a web page. | |
| | | | | The terminal can fetch further | |
| | | | | information by accessing this URL. | |
| Name | E1 | M | 1 . . . N | Name of the Content fragment, | String |
| | | | | possibly in multiple languages. The | |
| | | | | language is expressed using built-in | |
| | | | | XML attribute xml:lang with this | |
| | | | | element. | |

TABLE 6J

| Name | Type | Category | Cardinality | Description | Data Type |
|---|---|---|---|---|---|
| Description | E1 | O | 0 . . . N | Description, possibly in multiple | String |
| | | | | languages. | |
| | | | | The language is expressed using built- | |
| | | | | in XML attribute xml:lang with this | |
| | | | | element. | |
| ParentalRating | E1 | O | 0 . . . N | The rating level defining criteria | Integer |
| | | | | parents may use to determine whether | |
| | | | | the associated item is suitable for | |
| | | | | access by children, defined according | |
| | | | | to the regulatory requirements of the | |
| | | | | service area The recommended age | |
| | | | | limit. | |
| | | | | This age limit rating level overrides the | |
| | | | | rating level age limit defined for the | |
| | | | | service during the validity of the | |
| | | | | Schedule fragment. | |
| | | | | If there are two overlapping schedule | |
| | | | | fragments with a different parental | |
| | | | | rating, then the one with most | |
| | | | | restrictive parental rating defined for | |
| | | | | the schedule fragment overrides the | |
| | | | | other. | |

TABLE 6K

| Name | Type | Category | Cardinality | Description | Data Type |
|---|---|---|---|---|---|
| TargetUserProfile | E1 | O | 0 . . . 1 | Profile of the users who the service or | |
| | | | | content is targeting. For example, age, | |
| | | | | gender, occupation, and so forth. | |
| | | | | Details of the sub-elements TBD. | |
| Genre | E1 | O | 0 . . . N | Classification of content associated | String |
| | | | | with characteristic form (e.g. comedy, | |
| | | | | drama). | |
| UserRating | E1 | O | 0 . . . 1 | Rating information collected from users | Integer |
| | | | | (e.g. favoritism, or recommended age | |
| | | | | limit). | |
| broadcast_area | E1 | O | 0 . . . 1 | Broadcast area to include location | |
| | | | | information for BCAST contents | |
| | | | | Sub-elements: | |
| | | | | target_area | |

TABLE 6L

| Name | Type | Category | Cardinality | Description | Data Type |
|---|---|---|---|---|---|
| target_area | E2 | O | 0 . . . N | The target area to distribute contents | |
| | | | | (as specified in the [OMA MLP] with | |
| | | | | modifications). | |
| | | | | Sub-elements: | |
| | | | | Shape | |
| | | | | cc | |
| | | | | name_area | |
| | | | | zip_code | |
| shape | E3 | O | 0 . . . 1 | Shapes used to represent a geographic | See |
| | | | | area that describes (as specified in the | [OMA |
| | | | | [OMA MLP]). | MLP] |
| cc | E3 | O | 0 . . . 1 | Country code, 1-3 digits e.g. 355 for | See |
| | | | | Albania (as specified in the [OMA | [OMA |
| | | | | MLP]). | MLP] |
| name_area | E3 | O | 0 . . . 1 | Geopolitical name of area such as | See |
| | | | | ‘Seoul’ (as specified in the [OMA | [OMA |
| | | | | MLP]). | MLP] |
| zip_code | E3 | O | 0 . . . 1 | Zip code | Integer |

TABLE 6M

| Name | Type | Category | Cardinality | Description | Data Type |
|---|---|---|---|---|---|
| FileDescription | E1 | O | 0 . . . 1 | Description of a file or files related to | |
| | | | | this content. | |
| | | | | Attributes: | |
| | | | | Content-Length | |
| | | | | Transfer-Length | |
| | | | | Content-Type | |
| | | | | Content-Encoding | |
| | | | | Content-MD5 | |
| Content-Length | A | O | 0 . . . 1 | See RFC 3926, section 3.4.2 | unsignedLong |
| Transfer-Length | A | O | 0 . . . 1 | See RFC 3926, section 3.4.2 | unsignedLong |
| Content-Type | A | O | 0 . . . 1 | See RFC 3926, section 3.4.2 | String |
| Content- | A | O | 0 . . . 1 | See RFC 3926, section 3.4.2 | String |
| Encoding | | | | | |

TABLE 6N

| Name | Type | Category | Cardinality | Description | Data Type |
|---|---|---|---|---|---|
| ScheduleInfo | | | | Schedule fragment | |
| | | | | Contains the following attributes: | |
| | | | | id | |
| | | | | version | |
| | | | | ServiceIDRef | |
| | | | | Contains the following sub-elements: | |
| | | | | InteractivityDataIDRef | |
| | | | | ContentIDRef | |
| | | | | ExtensionURL | |
| | | | | Name | |
| | | | | Description | |
| id | A | M | 1 | ID of the Schedule fragment, globally | AnyURI |
| | | | | unique. | |
| version | A | M | 1 | Version of this fragment. The newer | unsignedInt |
| | | | | version overrides the older one as soon | (32 bits) |
| | | | | as it has been received. | |
| ServiceIDRef | A | M | 1 | Reference to the service fragment to | AnyURI |
| | | | | which the schedule fragment belongs | |

TABLE 6O

| Name | Type | Category | Cardinality | Description | Data Type |
|---|---|---|---|---|---|
| InteractivityData | E1 | O | 0 . . . N | Reference to the interactivity data | AnyURI |
| IDRef | | | | fragment to which the schedule | |
| | | | | fragment belongs. | |
| | | | | This IDRef declares the schedule of the | |
| | | | | file delivery of the InteractivityMedia | |
| | | | | Documents to which the | |
| | | | | InteractivityData fragment points to. | |
| | | | | An InteractivityData fragment can be | |
| | | | | associated with a ScheduleItem | |
| | | | | fragment as well, but that is preferably | |
| | | | | not the purpose of this IDRef. | |
| | | | | It contains the following attributes: | |
| | | | | idRef | |
| | | | | AutoStart | |
| | | | | It contains the following sub-elements: | |
| | | | | Distribution_Window | |
| | | | | The presentation window is actually | |
| | | | | declared by the “Valid_From” and | |
| | | | | “Valid_To” values in the Media Object | |
| | | | | Document. | |

TABLE 6P

| Name | Type | Category | Cardinality | Description | Data Type |
|---|---|---|---|---|---|
| idRef | A | M | 1 | Identification of the interactivity data | AnyURI |
| | | | | fragment which the Schedule fragment | |
| | | | | relates to. | |
| AutoStart | A | O | 0 . . . 1 | Indicates whether the associated | Boolean |
| | | | | interactivity data will be automatically | |
| | | | | activated. | |
| | | | | If the value of AutoStart is true, the | |
| | | | | associated interactivity data will be | |
| | | | | automatically activated at the validity | |
| | | | | of the media object document. | |
| | | | | If the value of AutoStart is false, the | |
| | | | | associated interactivity data will not be | |
| | | | | automatically activated, but can be | |
| | | | | activated at any time of the validity of | |
| | | | | the media object document upon the | |
| | | | | user's request. | |
| | | | | It is recommended that the terminal | |
| | | | | settings allow the users to configure | |
| | | | | whether to allow interactivity data to be | |
| | | | | automatically activated without users' | |
| | | | | request. | |

TABLE 6Q

| Name | Type | Category | Cardinality | Description | Data Type |
|---|---|---|---|---|---|
| Distribution_Window | E2 | O | 0 . . . N | Time interval in which the referenced | |
| | | | | interactivity data specified by | |
| | | | | ContentID is available for delivery. | |
| | | | | It contains the following attributes: | |
| | | | | Distribution_Start_Time | |
| | | | | Distribution_End_Time | |
| | | | | DWid | |
| | | | | It contains the following sub-elements: | |
| | | | | RepeatType | |
| Distribution_Start_Time | A | O | 0 . . . 1 | Start of Distribution_Window. If not | Integer (32 |
| | | | | given, the validity is assumed to have | bits) |
| | | | | begun at some time in the past. | expressed |
| | | | | | as NTP |
| | | | | | time. |
| Distribution_End_Time | A | O | 0 . . . 1 | End of Distribution_Window. If not | Integer (32 |
| | | | | given, the validity is assumed to end in | bits) |
| | | | | undefined time in the future. | expressed |
| | | | | | as NTP |
| | | | | | time. |
| DWid | A | O | 0 . . . 1 | Identification of the | Integer |
| | | | | Distribution_Window which each | |
| | | | | Distribution_Window relates to. | |

TABLE 6R

| Name | Type | Category | Cardinality | Description | Data Type |
|---|---|---|---|---|---|
| RepeatType | E3 | O | 0 . . . 1 | Indicates whether the interactivity data | |
| | | | | referenced by the ContentID is repeated | |
| | | | | in distribution according to the | |
| | | | | attributes Unit and Number. | |
| Unit | A | M | 1 | Indicates the unit of time (e.g. hours, | Integer |
| | | | | days, . . .) for which the content is | |
| | | | | repeated in distribution. | |
| Num | A | M | 1 | Number of Units | Integer |
| ContentIDRef | E1 | O | 0 . . . N | Reference to the content fragments that | |
| | | | | the schedule fragment relates to. | |
| | | | | It contains the following attributes: | |
| | | | | idRef | |
| | | | | AutoStart | |
| | | | | RepeatPlayback | |
| | | | | It contains the following sub-elements: | |
| | | | | Distribution_Window | |
| | | | | Presentation_Window | |
| idRef | A | M | 1 | Identification of the Content fragment | AnyURI |
| | | | | which the Schedule fragment relates to. | |

TABLE 6S

| Name | Type | Category | Cardinality | Description | Data Type |
|---|---|---|---|---|---|
| AutoStart | A | O | 0 . . . 1 | Indicates whether the associated | Boolean |
| | | | | content will be automatically activated. | |
| | | | | If the value of AutoStart is true, the | |
| | | | | associated content will be automatically | |
| | | | | activated at Presentation_Start_Time of | |
| | | | | every affiliated Presentation_Window | |
| | | | | without the user's request. Afterwards, | |
| | | | | as long as Presentation_End_Time of | |
| | | | | Presentation_Window has not elapsed, | |
| | | | | the content can further be activated at | |
| | | | | any other time upon the user's request. | |
| | | | | If the value of AutoStart is false, the | |
| | | | | associated content will not be | |
| | | | | automatically activated, but can be | |
| | | | | activated at any time between | |
| | | | | Presentation_Start_Time and | |
| | | | | Presentation_End_Time of every | |
| | | | | affiliated Presentation_Window upon | |
| | | | | the user's request. | |
| | | | | It is recommended that the terminal | |
| | | | | settings allow the users to configure | |
| | | | | whether to allow content to be | |
| | | | | automatically activated without users' | |
| | | | | request. | |
| RepeatPlayback | A | O | 0 . . . 1 | Indicates whether the content item | Boolean |
| | | | | referenced by the Presentation Window | |
| | | | | and/or Distribution Window in the | |
| | | | | Schedule fragment is of the repeat | |
| | | | | playback type. | |

TABLE 6T

| Name | Type | Category | Cardinality | Description | Data Type |
|---|---|---|---|---|---|
| Distribution_Window | E2 | O | 0 . . . N | Time interval in which the referenced | |
| | | | | content specified by ContentID is | |
| | | | | available for delivery. | |
| | | | | It contains the following attributes: | |
| | | | | Distribution_Start_Time | |
| | | | | Distribution_End_Time | |
| | | | | DWid | |
| | | | | It contains the following sub-elements: | |
| | | | | RepeatType | |
| Distribution_Start_Time | A | O | 0 . . . 1 | Start of Distribution_Window. If not | Integer (32 |
| | | | | given, the validity is assumed to have | bits) |
| | | | | begun at some time in the past. | expressed |
| | | | | | as NTP |
| | | | | | time. |
| Distribution_End_Time | A | O | 0 . . . 1 | End of Distribution_Window. If not | Integer (32 |
| | | | | given, the validity is assumed to end in | bits) |
| | | | | undefined time in the future. | expressed |
| | | | | | as NTP |
| | | | | | time. |
| DWid | A | O | 0 . . . 1 | Identification of the | Integer |
| | | | | Distribution_Window which the each | |
| | | | | Distribution_Window relates to. | |

TABLE 6U

| Name | Type | Category | Cardinality | Description | Data Type |
|---|---|---|---|---|---|
| RepeatType | E3 | O | 0 . . . 1 | Indicates whether the content | |
| | | | | referenced by the ContentID is repeated | |
| | | | | in distribution according to the | |
| | | | | attributes Unit and Number. | |
| Unit | A | M | 1 | Indicates the unit of time (e.g. hours, | Integer |
| | | | | days, . . . . ) for which the content is | |
| | | | | repeated in distribution. | |
| Num | A | M | 1 | Number of Units | Integer |
| Presentation_Window | E2 | O | 0 . . . N | Time interval in which the referenced | |
| | | | | content specified by ContentID is | |
| | | | | available for rendering. It contains the | |
| | | | | following attributes: | |
| | | | | Presentation_Start_Time | |
| | | | | Presentation_End_Time | |
| | | | | Duration | |
| | | | | It contains the following sub-elements: | |
| | | | | RepeatType | |
| Presentation_Start_Time | A | O | 0 . . . 1 | Start of Presentation_Window. If not | Integer (32 |
| | | | | given the validity is assumed to have | bits) |
| | | | | begun at some time in the past. | expressed |
| | | | | | as NTP |
| | | | | | time. |

TABLE 6V

| Name | Type | Category | Cardinality | Description | Data Type |
|---|---|---|---|---|---|
| Presentation_End_Time | A | O | 0 . . . 1 | End of Presentation_Window. If not | Integer (32 |
| | | | | given, the validity is assumed to end in | bits) |
| | | | | undefined time in the future. | expressed |
| | | | | | as NTP |
| | | | | | time |
| Duration | A | O | 0 . . . 1 | Time duration of the referenced content | Integer |
| | | | | for rendering. It informs the user the | |
| | | | | latest Presentation_Start_Time for | |
| | | | | which the content item can be rendered | |
| | | | | in its entirety. | |
| RepeatType | E3 | O | 0 . . . 1 | Indicates whether the content | |
| | | | | referenced by the ContentID is repeated | |
| | | | | in presentation according to the | |
| | | | | attributes Unit and Number. | |
| Unit | A | O | 1 | Indicates the unit of time (e.g. hours, | Integer |
| | | | | days . . . . ) for which the content is | |
| | | | | repeated in presentation. | |
| Num | A | O | 1 | Number of Units | Integer |
| ExtensionURL | E1 | O | 0 . . . N | URL containing additional information | AnyURI |
| | | | | related to this fragment in a web page. | |
| | | | | The terminal can fetch further | |
| | | | | information by accessing this URL. | |
| Name | E1 | M | 1 . . . N | Name of the Schedule, possibly in | String |
| | | | | multiple languages. | |
| | | | | The language is expressed using built- | |
| | | | | in XML attribute xml:lang with this | |
| | | | | element. | |
| Description | E1 | O | 0 . . . N | Description, possibly in multiple | String |
| | | | | languages. | |
| | | | | The language is expressed using built- | |
| | | | | in XML attribute xml:lang with this | |
| | | | | element. | |

TABLE 6W

| Name | Type | Category | Cardinality | Description | Data Type |
|---|---|---|---|---|---|
| Interactivity | | | | InteractivityData fragment. | |
| DataInfo | | | | Contains the following attributes: | |
| | | | | id | |
| | | | | version | |
| | | | | ServiceID | |
| | | | | ContentID | |
| | | | | ScheduleID | |
| | | | | PrelistenIndicator | |
| | | | | InteractivityMediaDocument | |
| | | | | Pointer | |
| | | | | Contains the following sub-elements: | |
| | | | | TimeWindow | |
| | | | | ExtensionURL | |
| id | A | M | 1 | ID of the InteractivityData fragment, | AnyURI |
| | | | | globally unique. | |
| version | A | M | 1 | Version of this fragment. The newer | unsignedInt |
| | | | | version overrides the older one as soon | (32 bits) |
| | | | | as it has been received. | |
| ServiceID | A | M | 1 . . . N | Reference to the service fragment that | AnyURI |
| | | | | the InteractivityData fragment is | |
| | | | | associated with. | |
| ContentID | A | O | 0 . . . N | Reference to the content fragments that | AnyURI |
| | | | | the InteractivityData fragment is | |
| | | | | associated with. | |

TABLE 6X

| Name | Type | Category | Cardinality | Description | Data Type |
|---|---|---|---|---|---|
| ScheduleID | A | O | 0 . . . N | Reference to the schedule fragments that | AnyURI |
| | | | | the InteractivityData fragment is | |
| | | | | associated with. | |
| | | | | Contains attributes | |
| | | | | PresentationWindowID | |
| | | | | The PresentationWindowIDs declared in | |
| | | | | this attribute preferably shall be the | |
| | | | | complete collection or a subset of the | |
| | | | | PWId's declared in the ScheduleID | |
| | | | | fragment, to which this reference belongs. | |
| PresentationWindowID | A | O | 0 . . . N | Relation reference to the | AnyURI |
| | | | | PresentationWindowID to which the | |
| | | | | access fragment belongs. | |
| InteractivityWindow | E1 | O | 0 . . . N | Time interval during which this | AnyURI |
| | | | | InteractivityData fragment is associated | |
| | | | | with the service specified by service ID. | |
| | | | | TimeWindow has the following attributes | |
| | | | | InteractivityWindowStartTime | |
| | | | | InteractivityWindowEndTime | |
| InteractivityWindowStartTime | A | M | 1 | Start of the InteractivityWindow. | Integer |
| | | | | Whenever a InteractivityWindow is | (32 bits) |
| | | | | specified, StartTime preferably shall be | expressed |
| | | | | declared. | as NTP |
| | | | | | time. |
| InteractivityWindowEndTime | A | M | 1 | End of the InteractivityWindow. | Integer |
| | | | | Whenever a InteractivityWindow is | (32 bits) |
| | | | | specified, EndTime preferably shall be | expressed |
| | | | | declared. | as NTP |
| | | | | | time. |

TABLE 6Y

| Name | Type | Category | Cardinality | Description | Data Type |
|---|---|---|---|---|---|
| Pre- | A | O | 1 | If the Pre-ListenIndicator is “true” the | Boolean |
| listenIndicator | | | | terminal preferably shall retrieve and | |
| | | | | locally store the Interactivity media | |
| | | | | objects included in the | |
| | | | | InteractivityMedia documents carried | |
| | | | | in the broadcast stream. The terminal | |
| | | | | preferably shall start the retrieval of | |
| | | | | these Interactivity media objects prior | |
| | | | | to the broadcast time of the Service, | |
| | | | | Content, Schedule or | |
| | | | | InteractivityWindow it is associated | |
| | | | | with, or as soon as the InteractivityData | |
| | | | | fragment is retrieved by the terminal. | |
| | | | | If the Pre-listenIndicator is “false” the | |
| | | | | terminal preferably may not retrieve the | |
| | | | | Interactivity media objects included in | |
| | | | | the InteractivityMedia documents, until | |
| | | | | the Service, Content, Schedule or | |
| | | | | InteractivityWindow it is associated | |
| | | | | with, is broadcasted. | |
| InteractivityMediaDocument | A | O | 1 | Reference to the GroupID of the | AnyURI |
| Pointer | | | | Interactivity_Media Documents which | |
| | | | | carry the interactivity media objects. | |
| | | | | The pointer points to all | |
| | | | | InteractivityMedia Documents with the | |
| | | | | same GroupID. The InteractivityMedia | |
| | | | | Document with the highest | |
| | | | | GroupPosition is rendered. | |
| ExtensionURL | E1 | O | 1 | URL containing InteractionData | AnyURI |
| | | | | elements related to this fragment in a | |
| | | | | web page on a network server. The | |
| | | | | terminal can fetch this information by | |
| | | | | accessing this URL. | |

TABLE 7

| Name | Type | Category | Cardinality | Description | Data Type |
|---|---|---|---|---|---|
| SGASRes | | | | Specifies the Response message for | |
| | | | | SGASReq. | |
| | | | | Contains the following elements: | |
| | | | | SGASId | |
| SGASId | E1 | M | 0 . . . N | Identifier of the SGASReq Message | unsignedInt |
| | | | | provided by SGAS. | (32 bits) |
| | | | | Contains the following attributes: | |
| | | | | Response | |
| Response | A | M | 1 | Specifies the result how SGAS is | Integer |
| | | | | handled in SG-G. | (8 bits) |
| | | | | If Response = 0, Service Guide is | |
| | | | | generated by SGASReq specified with | |
| | | | | SGASId. | |
| | | | | If Response = 1, Service Guide | |
| | | | | Generation is failed and Retransmission | |
| | | | | is requested. | |

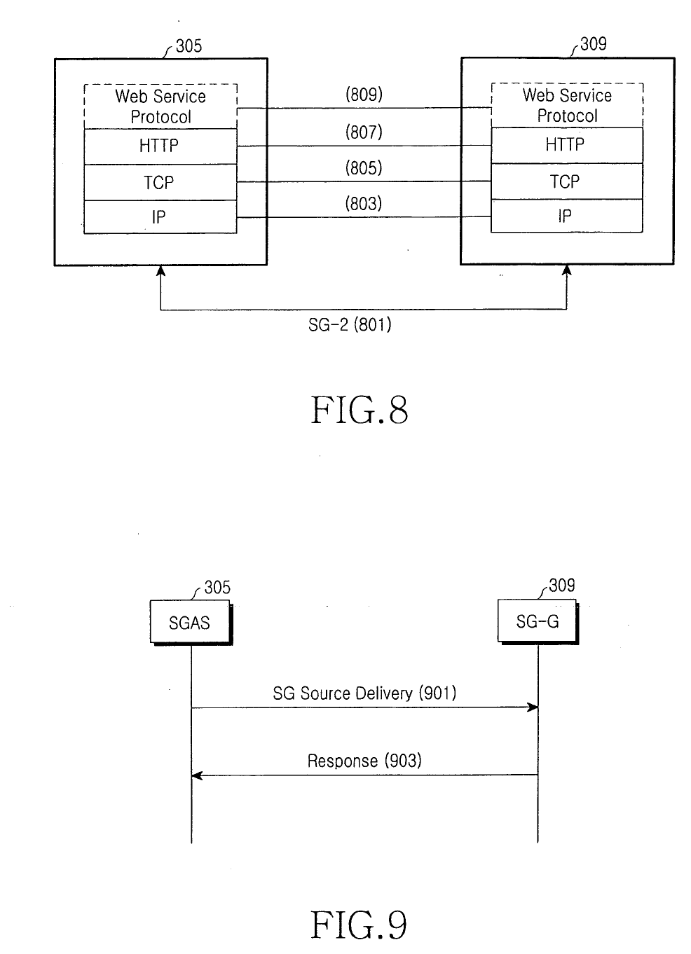

FIG. 8 is a block diagram illustrating an exemplary protocol stack used for delivering a request message for service guide source provisioning according to an embodiment of the present invention. As illustrated in FIG. 8, an SG-2 interface is used as a backend interface for a request for provisioning of a service guide source between the SGAS 305 and the SG-G 309.

Referring to FIGS. 3 and 8, for message delivery over an SG-2 interface 801, HTTP 807 based on IP 803 and TCP 805 is used substantially the same as shown in FIG. 6. As another example, Web Service Protocol 809 for XML data transmission, like Simple Object Access Protocol (SOAP), Extensible Markup Language-Remote Procedure Call (XML-RPC), Blocks Extensible Exchange Protocol (BEEP) and so forth, can be used in an upper layer of the HTTP 807. When the Web Service Protocol 809 is used, a message in accordance with an embodiment of the present invention is included in Body of the Web Service Protocol.

FIG. 9 is an exemplary signaling diagram illustrating an operation of delivering a request message for service guide source provisioning according to an embodiment of the present invention. That is, a signaling diagram is shown illustrating an operation of delivering a service guide source necessary for the generation of a service guide, over an SG-2 interface 801.

Referring to FIGS. 3 and 9, in step 901, the SGAS 305 delivers the service guide source data necessary for service guide generation to the SG-G 309 using the SG-2 interface 801. The message format (XML schema) used for delivering the service guide source data is shown by way of example in Table 8A and Table 8B below. In step 903, the SG-G 309 sends the processing result, shown by way of example in Table 9, on the service guide source data to the SGAS 305 in response to the request.

TABLE 8A

| Name | Type | Category | Cardinality | Description | Data Type |
|---|---|---|---|---|---|
| SGSDelivery | | | | Specifies the delivery message | |
| | | | | of Service Guide Source which | |
| | | | | is used for generating Service | |
| | | | | Guide in SG-G. | |
| | | | | Contains the Following | |
| | | | | attributes: | |
| | | | | SGSDid | |
| | | | | EntityAddress | |
| | | | | Contains the following | |
| | | | | elements: | |
| | | | | SGData | |
| SGSDid | A | M | 1 | Identifier of SGSDelivery, | unsignedInt |
| | | | | unique in Network Entity which | (32 bits) |
| | | | | generated this message. | |
| EntityAddress | A | M | 1 | Network Entity Address which | AnyURI |
| | | | | generate this message and | |
| | | | | receive the response. | |

TABLE 8B

| Name | Type | Category | Cardinality | Description | Data Type |
|---|---|---|---|---|---|
| SGData | E1 | O | 0 . . . 1 | Contains information from the | |
| | | | | Content Creation to be included | |
| | | | | in the Service Guide. It is | |
| | | | | recommended that the | |
| | | | | information is delivered in the | |
| | | | | form of BCAST Service Guide | |
| | | | | fragments. Other formats can be | |
| | | | | used. | |
| | | | | If BCAST Service Guide | |
| | | | | fragments are used, network- | |
| | | | | mandatory elements or attributes | |
| | | | | which are not relevant preferably | |
| | | | | shall be delivered as empty fields, | |
| | | | | and network-optional elements or | |
| | | | | attributes which are not relevant | |
| | | | | preferably shall not be | |
| | | | | instantiated. | |
| | | | | Contains attribute: | |
| | | | | namespace | |
| namespace | A | O | 0 . . . 1 | Set to the name of the BCAST | AnyURI |
| | | | | Service Guide XML namespace | |
| | | | | to signal that the content of | |
| | | | | SGData is BCAST SG compliant. | |

TABLE 9

| Name | Type | Category | Cardinality | Description | Data Type |
|---|---|---|---|---|---|
| SGSDRes | | | | Specifies the Response | |
| | | | | message for SGSDelivery. | |
| | | | | Contains the following | |
| | | | | elements. | |
| | | | | SGSDid | |
| SGSDid | E1 | M | 1 . . . N | Identifier of SGSDelivery | UnsignedInt |
| | | | | Message. | (32 bit) |
| | | | | Contains the following | |
| | | | | attributes: | |
| | | | | StatusCode | |
| StatusCode | A | M | 1 | Indicates the overall outcome | unsignedByte |
| | | | | how SGSDelivery is | |
| | | | | processed, according to the | |
| | | | | global status code. | |

Table 10 below shows exemplary status codes included in the response message shown in Table 9. That is, the response messages include the status codes indicating the processing results on the service guide source data. If the service guide source data has been normally processed, the status code is set to ‘000’, and the terminal recognizes the successful processing result according to the corresponding status code. For convenience, Table 10 is divided into Table 10A to Table 10G.

Table 10 is stored in the network entity and terminal that send the response message, for future use, and additional status codes can be defined according to a purpose of the service provider. Values of the status codes shown in Table 10 can be used in the global use for the response message associated with embodiments of the present invention, and also for all cases where the system or terminal supporting the mobile broadcast service should send a response with the processing result. Accordingly, the status code is also known as a global status code.

TABLE 10A

| Code | Status |
|---|---|
| 000 | Success |
| | The request was processed successfully. |
| 001 | Device Authentication Failed |
| | This code indicates that the BSM was unable to authenticate the device, which may be due to |
| | the fact that the user or the device is not registered with the BSM. |
| | In this case, the user may contact the BSM and establish a contract, or get the credentials in |
| | place that are used for authentication. |
| 002 | User Authentication Failed |
| | This code indicates that the BSM was unable to authenticate the user, which may be due to the |
| | fact that the user or the device is not registered with the BSM. |
| | In this case, the user may contact the BSM and establish a contract, or get the credentials in |
| | place that are used for authentication. |
| 003 | Purchase Item Unknown |
| | This code indicates that the requested service item is unknown. This can happen e.g. if the |
| | device has a cached service guide with old information. |
| | In this case, the user may re-acquire the service guide. |

TABLE 10B

| Code | Status |
|---|---|
| 004 | Device Authorization Failed |
| | This code indicates that the device is not authorized to get Long-Term Key Messages from the |
| | RI, e.g. because the device certificate was revoked. |
| | In this case, the user may contact the BSM operator. |
| 005 | User Authorization Failed |
| | This code indicates that the user is not authorized to get Long-Term Key Messages from the RI, |
| | e.g. because the device certificate was revoked. |
| | In this case, the user may contact the BSM operator. |
| 006 | Device Not Registered |
| | This code indicates that the device is not registered with the RI that is used for the transaction |
| | When this code is sent, the response message includes a registration trigger that allows the |
| | device to register. |
| | In this case, the device may automatically perform the registration, and, if the registration is |
| | successful, re-initiate the original transaction. |
| 007 | Server Error |
| | This code indicates that there was a server error, such as a problem connecting to a remote |
| | back-end system. |
| | In such a case, the transaction may succeed if it is re-initiated later. |

TABLE 10C

| Code | Status |
|---|---|
| 008 | Mal-formed Message Error |
| | This code indicates that there has been a device malfunction, such as a mal-formed XML |
| | request. |
| | In such a case, the transaction may or may not (e.g. if there is an interoperability problem) |
| | succeed if it is re-initiated later. |
| 009 | Charging Error |
| | This code indicates that the charging step failed (e.g. agreed credit limit reached, account |
| | blocked and so forth) and therefore, the requested Long-Term Key Message cannot be |
| | provided. |
| | The user may in such a case, contact the BSM operator. |
| 010 | No Subscription |
| | This code indicates that there has never been a subscription for this service item, or that the |
| | subscription for this item has terminated. |
| | The user may in such a case issue a service request for a new subscription. |
| 011 | Operation not Permitted |
| | This code indicates that the operation that the device attempted to perform is not permitted |
| | under the contract between BSM and user. |
| | The user may in this case, contact the BSM operator and change the contract. |

TABLE 10D

| Code | Status |
|---|---|
| 012 | Unsupported version |
| | This code indicates that the version number specified in the request message is not supported |
| | by the network. |
| | In this case, the user may contact the BSM operator. |
| 013 | Illegal Device |
| | This code indicates that the device requesting services are not acceptable to the BSM, e.g., |
| | blacklisted. |
| | In this case, the user may contact the BSM operator. |
| 014 | Service Area not Allowed |
| | This code indicates that the device is not allowed services in the requested area due to |
| | subscription limits |
| | In this case, the user may contact the BSM operator or subscribe to the applicable service. |
| 015 | Requested Service Unavailable |
| | This code indicates that the requested service is unavailable due to transmission problems. |
| | In this case, the request may be re-initiated at a later time. |

TABLE 10E

| Code | Status |
|---|---|
| 016 | Request already Processed |
| | This code indicates that an identical request has been previously processed. |
| | In this case, the user or the entity may check to see if the request had already been processed |
| | (i.e. received an LTK), and if not, retry the request. |
| 017 | Information Element Non-existent |
| | This code indicates that the message includes information elements not recognized because the |
| | information element identifier is not defined or it is defined but not implemented by the entity |
| | receiving the message. |
| | In this case related entities should contact each other. |
| 018 | Unspecified |
| | This code indicates that an error has occurred which cannot be identified. |
| | In this case related entities should contact each other. |
| 019 | Process Delayed |
| | Due to heavy load, request is in a queue, waiting to be processed. |
| | In this case the user or entity should wait for the transaction to complete. |

TABLE 10F

| Code | Status |
|---|---|
| 020 | Generation Failure |
| | This code indicates that the request information (message) |
| | could not be generated. |
| | In this case, the user or entity should retry later. |
| 021 | Information Invalid |
| | This code indicates that the information given is invalid and cannot |
| | be used by the system. |
| | In this case, the request should be rechecked and sent again. |
| 022 | Invalid Request |
| | This code indicates that the requesting key materials and messages |
| | (e.g., LTKM) are not valid and cannot be fulfilled. |
| | In this case, the request should be rechecked and sent again. |
| 023 | Wrong Destination |
| | This code indicates that the destination of the message is |
| | not the intended one. |
| | In this case, the request should be rechecked and sent again. |

TABLE 10G

| Code | Status |
|---|---|
| 024 | Delivery of Wrong Key Information |
| | This code indicates that the delivered key information and |
| | messages (e.g., LTKM) are invalid. |
| | In this case, the request should be rechecked and sent again. |
| 025˜127 | Reserved for future uses |
| 128˜255 | Reserved for proprietary uses |

As can be understood from the foregoing description, in the mobile broadcast system according to embodiments of the present invention, the network entity that generates a service guide receives service/content information and attributes or scheduling information, generates a service guide corresponding thereto, and then sends the generation result information to the source provider, thereby improving reliability.

Further, in transmitting the results, embodiments of the present invention send responses to a plurality of source provisioning requests with one message, contributing to improvements in network efficiency.

In addition, embodiments of the present invention can efficiently and effectively transmit a service guide to a mobile terminal.

While the present invention has been shown and described with reference to a certain exemplary embodiments thereof, it will be understood by those skilled in the art that various changes in form and detail may be made therein without departing from the spirit and scope of the invention as defined by the appended claims and equivalents.

What is claimed is:

1. A method for transmitting information for the generation of a service guide for a mobile broadcast service in a broadcast system supporting the mobile broadcast service, the method comprising:
transmitting, by a Content Creation (CC) block for providing a broadcast service, content/service information and attributes for the generation of a service guide to a Service Guide Application Source (SGAS) unit;
transmitting, by the SGAS, the service guide request message based on the content/service information and attributes to a Service Guide Generation (SG-G) unit over a backend interface; and
generating, by the SG-G, a service guide using data included in the service guide request message, and transmitting a service guide generation completion message indicating completion of the generation of the service guide to the SGAS.

2. The method of claim 1, wherein the service guide request message is transmitted using Hyper Text Transfer Protocol (HTTP) based on Internet Protocol (IP) and Transfer Control Protocol (TCP).

3. The method of claim 1, wherein the service guide request message is transmitted using Web Service Protocol.

4. The method of claim 1, wherein if the service guide is immediately generated and sent, the service guide generation completion message is transmitted by using an HTTP Response message including the ID or BSAAddress of the service guide generation request message.

5. The method of claim 1, wherein if the service guide is not immediately generated, the service guide generation completion message including a service guide identifier (ID) and a BSA address (BSAAddress) of a Service Guide Application Source request (SGASReq) is transmitted by using an HTTP POST message at a service guide generation completion time.

6. The method of claim 1, wherein the service guide request message comprises:
a unique identifier (SGASId) indicating the service guide request message;
a BSAAddress indicating a BSA address used for receiving the service guide request message; and
a data for the generation of a service guide.

7. The method of claim 6, wherein the data for the generation of a service guide includes at least one of content, schedule or interactivity data.

8. The method of claim 1, wherein the service guide generation completion message comprises:
an identifier (SGASId) indicating an ID of the SGASRes provided by the SGAS; and
a Response indicating a status of a result on an item requesting the service guide response message.

9. The method of claim 1, wherein the backend interface comprises an SG-2 interface.

10. An apparatus for transmitting information for the generation of a service guide for a mobile broadcast service in a broadcast system supporting the mobile broadcast service, the apparatus comprising:
a Content Creation (CC) block for transmitting content/service information and attributes for the generation of a service guide to a Service Guide Application Source (SGAS);
the SGAS for transmitting the service guide request message based on the content/service information and attributes to a Service Guide Generation (SG-G) unit over a backend interface; and
the SG-G for generating a service guide using data included in the service guide request message, and transmitting a service guide generation completion message indicating completion of the generation of the service guide to the SGAS.

11. The apparatus of claim 10, wherein the service guide request message is transmitted using Hyper Text Transfer Protocol (HTTP) based on Internet Protocol (IP) and Transfer Control Protocol (TCP).

12. The apparatus of claim 10, wherein the service guide request message is transmitted using Web Service Protocol.

13. The apparatus of claim 10, wherein if the service guide is immediately generated and sent, the service guide generation completion message is transmitted by using an HTTP Response message including the ID or BSAAddress of the service guide request message.

14. The apparatus of claim 10, wherein if the service guide is not immediately generated, the service guide generation completion message including a service guide identifier (ID) and a BSA address (BSAAddress) of a Service Guide Application Source request (SGASReq) is transmitted by using an HTTP POST message at a service guide generation completion time.

15. The apparatus of claim 10, wherein the service guide request message comprises:
a unique identifier (SGASId) indicating the service guide request message;
a BSAAddress indicating a BSA address used for receiving the service guide request message; and
a data for the generation of a service guide.

16. The apparatus of claim 15, wherein the data for the generation of a service guide includes at least one of content, schedule or interactivity data.

17. The apparatus of claim 10, wherein the service guide generation completion message comprises:
an identifier (SGASId) indicating an ID of the SGASRes provided by the SGAS; and
a Response indicating a status of a result on an item requesting the service guide response message.

18. The apparatus of claim 10, wherein the backend interface comprises an SG-2 interface.
